(19) United States
(12) Patent Application Publication
(10) Pub. No.: US 2008/0163490 A1
(43) Pub. Date: Jul. 10, 2008

(54) Cable stripper

(76) Inventor: Darrel Cruse, Vancouver, WA (US)

Correspondence Address: K.M. RYLANDER;RYLANDER & ASSOCIATES, 406 West 12th Street, Vancouver, WA, 98660, US

(21) Appl. No.: 11/650,065

(22) Filed: Jan. 4, 2007

(51) Int. Cl. H02G 1/12

(52) U.S. Cl. 30/90.4

(57) ABSTRACT

Applicant's cable stripper for stripping the sheath of a cable while protecting the underlying cable wire and cable wire sheaths, includes a handle configured to be normal to a cable during with the user's hand-arm line substantially parallel to the axis of the cable, a hook with a shoe having rounded edges and a tapered end, and a blade located on said hook such that said blade is substantially parallel to said handle and substantially normal to said cable axis. In one embodiment, blade is finger safe to the adult male finger. In one embodiment, cable stripper includes a container fillable with lubricant attached to said cable stripper, and an internal channel from said hook through said blade to said shoe such that said internal channel slopes downward toward one end of said shoe dispensing said container's lubricant down said channel and at one end of said shoe. In one embodiment, lubricant dispenses from container through an exterior tube that terminates at one end of said shoe.

### FIELD OF THE INVENTION

Applicant's cable stripper relates to apparatuses and devices for stripping electric cable.

### BACKGROUND

Cable strippers are used to cut cable sheaths and expose the underlying wire(s). Stripping the cable provides access to the underlying wire(s) for repair, replacement or splicing, which are part of necessary cable maintenance. Cable sheaths must often be stripped quickly, for a substantial distance and carefully. Caution is required during cable stripping to avoid cutting or nicking the underlying wire as well as to avoid injury to the user. Cable strippers are currently available but require the cable stripper user to hold the tool at an acute angle to the portion of the cable sheath nearest the tool's handle when in use. Moreover, cable strippers with shoes to guide the stripper do not always slide smoothly underneath the cable sheath. Thus, there is a need for a cable stripper that allows the user to ergonomically hold the cable stripper during use and lubricate the shoe.

A number of devices have provided cable strippers, but the art has not addressed these problems. The following represents a list of known related art:

| Reference: | Issued to: | Date of Issue: |
|---|---|---|
| U.S. Pat. No. 5,142,780 | Brewer | Sep. 1, 1992 |
| U.S. Pat. No. 3,162,945 | Stabs | Dec. 29, 1964 |
| U.S. Pat. No. 2,882,597 | Roth | Apr. 21, 1959 |
| U.S. Pat. No. 2,691,822 | Vaughan, Jr. | Oct. 19, 1954 |
| U.S. Pat. No. 2,601,414 | Mittelstaedt | Jun. 24, 1952 |
| U.S. Pat. No. 2,537,287 | Thomas | Jan. 9, 1951 |
| U.S. Pat. No. 2,398,979 | Vaughan, Jr. | Apr. 23, 1946 |
| U.S. Pat. No. 2,261,322 | Zabak | Nov. 4, 1941 |
| U.S. Pat. No. 1,328,547 | Shaw | Jan. 20, 1920 |
| U.S. Pat. No. 165,104 | Lane et al. | Jun. 29, 1875 |
| U.S. Des. Patent D518,349 | Francois | Apr. 4, 2006 |

The teachings of each of the above-listed citations (which does not itself incorporate essential material by reference) are herein incorporated by reference. None of the above inventions and patents, taken either singularly or in combination, is seen to describe the instant cable stripper as claimed.

U.S. Pat. No. 5,142,780 to Brewer entitled, “Electric Cable Stripping Tool with Claw,” teaches a tool for removing a cable sheath having a handle; a shank extending from the handle, having a top side from which a claw extends at an angle less than forty-five degrees; a claw having a “U”-shaped concave leading edge facing the handle, with a top segment extending forwardly and a bottom segment extending forwardly to join the shank and the blade; a downward extending blade, perpendicular from the shank, with a “U”-shaped concave cutting edge terminating in a shoe at the blade's lowest and most distal extremity; and a shoe having a generally flat bottom, rounded edge and sides, sufficiently thick to ensure bluntness of the leading edge, the sides converging rearwardly toward each other to merge at edge of said blade. Once the claw has created an opening in the cable sheath, the shoe is used to cut the sheath lengthwise. During tool use, the user's thumb and forefinger grab the cable to steady it during puncture and cutting.

U.S. Pat. No. 3,162,945 to Stabs entitled, “Stripper for Wire Cable Covering,” teaches a wire stripping device having a handle with a base portion; a thin, flat cutting blade, secured to the handle base portion, with an arcuate cutting edge on the forward end which terminates in converging rear and side edges, the rear edge having a sharpened portion; and a shoe member secured to the blade at the point of conversion.

U.S. Pat. No. 2,882,597 to Roth entitled, “Under-Edge Burring Tool,” teaches a tool for smoothing rough edges having a stem, a cutting blade with a longitudinal axis extending angularly outwardly and endwardly of the stem wherein one side of the blade forms an outside angle with the stem, a cutting edge on part of the blade forming the outside angle and a blade extension extending from a free end of the blade and having a smooth endwardly converging wall. The blade extension is rounded throughout its length and joined to the blade; a portion of the wall adjacent the blade forms an obtuse angle with the longitudinal axis of the cutting blade.

U.S. Pat. No. 2,691,822 to Vaughan, Jr. entitled, “Cable Stripping Tool,” teaches a tool having a shank with a cutting blade secured to the shank with a cutting edge at a right angle to the shank; a bottom edge runner shoe extending from one side of the cutting blade laterally; the cutting edge is beveled.

U.S. Pat. No. 2,601,414, to Mittelstaedt entitled, “Fabric Cutter,” teaches a knife for cutting sheet material having a U-shaped frame with a pair of parallel legs and a curved bight portion joining the legs at one end; one of the legs tapers in thickness from a midpoint to its distal end with a slot for a blade; the other leg has a handle at its distal end.

U.S. Pat. No. 2,537,287, to Thomas entitled, “Implement for Cutting Carpets and the Like,” teaches a tool having a head and a handle; a bracket member fixed to the head and extending downward with a rigid runner at the bottom; opposed clamping disks; a blade on the head between the bracket and runner and the clamping disks. The disks serve as visual sighting and tracing means. The clamping disks may be releasable.

U.S. Pat. No. 2,398,979, to Vaughan, Jr. entitled, “Cable Stripping Tool,” teaches a tool having a blade with a vertical inner cutting edge, a flange on the lower edge of the blade projecting laterally, a shoe on the inner end of the flange and a handle means.

U.S. Pat. No. 2,261,322, to Zabak entitled, “Butchering Knife,” teaches a butcher knife having a blade with a shank, a handle secured to the shank, the blade extends forwardly from the handle at an inclined angle in a direction toward the back edge of the handle, the blade's front edge bent to one side of the blade and a curved hook-shaped extension at the upper forward edge of the blade extending in a direction opposite from the bent edge and terminating in a pointed extremity.

U.S. Pat. No. 1,328,547, to Shaw entitled, “Tool for Cutting Tire Treads,” teaches a tool with a blade body which is wide at one end and is provided with a dull bearing edge about the length of the blade; the outer blade end having a hook portion with a cutting edge at an acute angle to the dull inclined bearing edge; the cutting edge terminating in a pointed part with a wide portion at one end of the blade body having a gradual curved belly part constituting a fulcruming bearing adapted to fulcrum upon the tread surface of a tire.

U.S. Pat. No. 165,104, to Lane et al. entitled “Tobacco-Knife,” teaches a double-edged blade with a guarded handle, whose two wooden parts are at right angles to each other.

U.S. Design Pat. No. D518,349, to Francois entitled “Utility Knife for Horse/Bull Riders,” depicts a two-part knife with a blade having a curved hook wherein the sharp portions of the blade are opposite one another within the curved hook portion; and a handle at an obtuse angle to the non-curved portion of the blade.

Still other features would be desirable in a cable stripper. For example, a blade that prevents the user from injuring fingers during storage and use, as well as a handle oriented to the blade in such a manner as to allow the user to ergonomically use the cable stripper.

Thus, while the foregoing body of art indicates it to be well known to have a cable stripper, the art described above does not teach or suggest a cable stripper which has the following combination of desirable features: (1) finger safe blade, (2) ergonomic positioning of the handle during use.

### SUMMARY AND ADVANTAGES

Applicant's cable stripper for stripping the sheath of a cable while protecting the underlying cable wire and cable wire sheaths, includes a handle configured to be normal to a cable with the user's hand-arm line substantially parallel to the axis of the cable, a hook with a shoe having rounded edges and a tapered end, and a blade located on said hook such that said blade is substantially parallel to said handle and substantially normal to said cable axis. In one embodiment, blade is finger safe to the adult male finger. In one embodiment, cable stripper includes a container fillable with lubricant attached to said cable stripper, and an internal channel from said hook through said blade to said shoe such that said internal channel slopes downward toward one end of said shoe dispensing said container's lubricant down said channel and at one end of said shoe. In one embodiment, lubricant dispenses through container along an exterior tube that terminates at one end of said shoe.

Applicant's cable stripper presents numerous advantages, including: (1) finger safe blade, (2) ergonomic positioning of handle during use, (3) lubrication of the shoe, (4) mechanism for lubricating the shoe during use without removal from the cable sheath. Additional advantages will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of Applicant's cable stripper and, together with the detailed description, serve to explain the principles and implementations of the invention.

FIG. 1 shows a side view of an embodiment of Applicant's cable stripper.

FIG. 2 shows a rear view of the embodiment of Applicant's cable stripper shown in FIG. 1.

FIG. 3 shows a side view of an alternate embodiment of Applicant's cable stripper.

FIG. 4 shows a side view of the lower portion of an alternate embodiment of Applicant's cable stripper.

FIG. 5 shows a side view of yet another alternate embodiment of Applicant's cable stripper.

FIG. 6 shows a rear view of the embodiment of Applicant's cable stripper shown in FIG. 5.

FIG. 7 shows a front view of an embodiment of the blade sheath for a cable stripper.

FIG. 8 shows a side view of an embodiment of Applicant's cable stripper with a lubricant dispenser.

FIG. 9 shows a side view of an embodiment of Applicant's cable stripper with an alternative configuration for a lubricant dispenser.

FIG. 10 shows a side view of an embodiment of Applicant's cable stripper in use.

FIG. 11 shows a cut-away of an embodiment of Applicant's cable stripper with the lubricant reservoir internal to the handle.

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Applicant's cable stripper 10, 10A for stripping the sheath S of a cable C while protecting the underlying cable wire W and cable wire sheaths H, includes a handle 12, 12A configured to be normal to a cable C with the user's hand-arm line substantially parallel to the axis of the cable C, a hook 14 with a shoe 16 having rounded edges and a tapered end, and a blade 18 located on said hook 14 such that said blade 18 is substantially parallel to said handle 12, 12A and substantially normal to said cable axis. In one embodiment, blade 18 is finger safe to the adult male finger F. In one embodiment, cable stripper 10 includes a container 28 fillable with lubricant L attached to said cable stripper 10, and an internal channel 32 from said hook through said blade to said shoe 16 such that said internal channel 32 slopes downward toward one end of said shoe 16 dispensing said container's 28 lubricant L down said channel 32 and at one end of said shoe 16. In one embodiment, lubricant L dispenses through container 28 along an exterior tube 34 that terminates at one end of said shoe 16.

A finger safe blade 18 prevents the user from cutting the user's finger on the blade 18. A finger safe blade 18 is of small enough length from the shoe 16 to the hook 14 that a user's finger F will not fit between the shoe 16 and the hook 14 and consequently, the finger will be unable to reach the blade 18 (see FIGS. 4). An adult human finger approximates 5/16 of an inch (0.794 cm) in width. Therefore, a blade 18 of the preferred length, 5/16 of an inch (0.794 cm), will not permit a user's finger to reach the blade 18 because the user's finger is prevented from doing so by the shoe 16 and the hook 14. One of ordinary skill in the art would realize that the blade 18 length may be customized according to the user in order to be finger safe. The blade 18 is preferably beveled, allowing the blade 18 to retain its sharpness under extensive use.

As shown in FIG. 7, a protective blade sheath 22 can cover the blade 18 when not in use. A blade sheath 22 includes a rigid curved material 22a that extends over the blade's 18 edge and wraps around the blade's 18 sides. As depicted in FIG. 7, a blade sheath 22 preferably includes a thin, curved piece of metal 22b forming a half-circle, covered on its exterior and interior face with a blunt material 22a, such as rubber or hard plastic. The interior covering of blunt material 22a preferably has two inward pointing flanges 22c to secure the blade sheath 22 in place during use. The inward pointing flanges 22c are triangular. The blade sheath 22 may be pulled off the blade 18 when the user is ready to use the cable stripper 10.

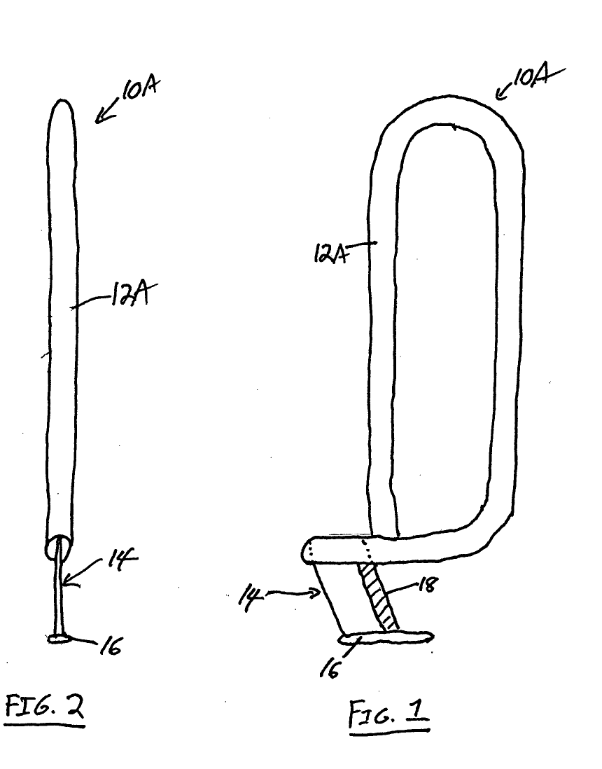

The handle 12 is substantially parallel either perpendicular to the blade 18, such that during use the handle 12 is normal to the axis of the cable C, allowing the user to maintain an ergonomic position during use with the user's arm along or substantially parallel to the cable C axis. The handle 12 may be a solid hexahedron with rounded edges for comfort during use. As shown in FIGS. 1-2, in an alternate embodiment, the handle 12 may also have an open interior and be elliptical on three sides with a right angle on the fourth. This embodiment permits the users to place at least one finger in the interior of the handle 12A for comfort during use.

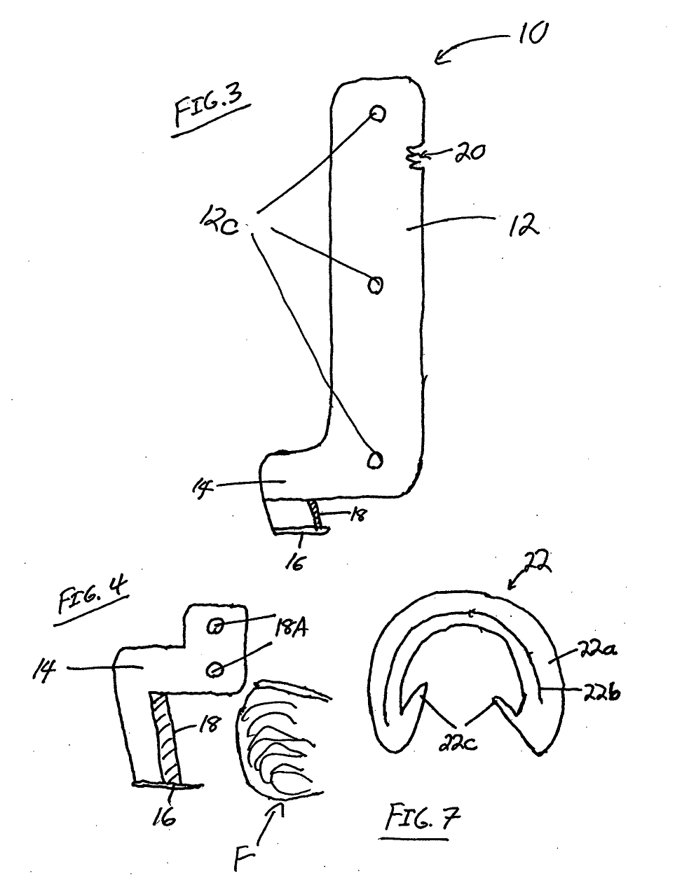

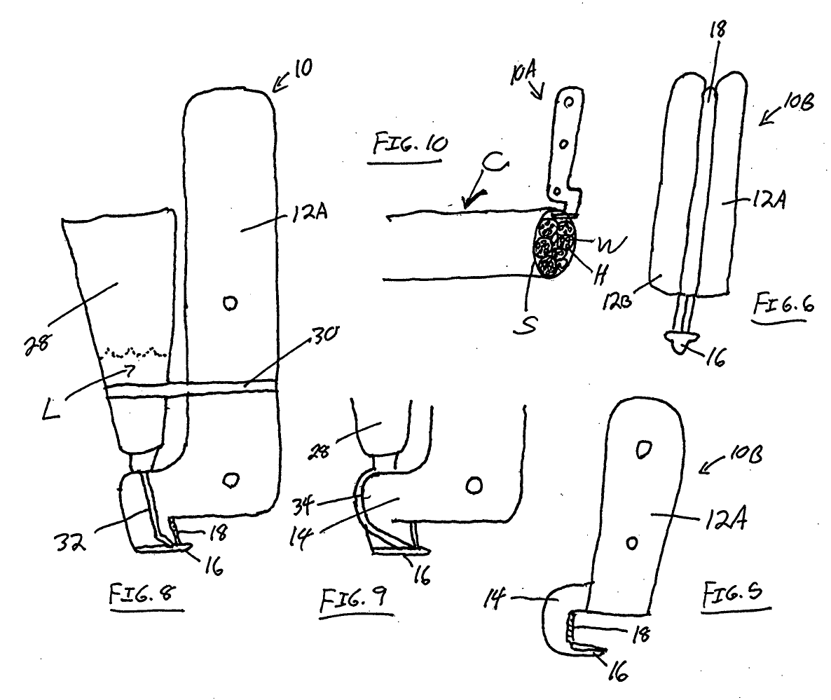

In the embodiment shown in FIGS. 3-6, 8-10, the handle 12 may include a first portion 12a and a second portion 12b and corresponding apertures 12c on said first and second portions 12a, 12b. In this embodiment, the blade 18 has a long, extended portion having apertures 18a corresponding to the first and second portion apertures 12c which can be secured between said first and second portions 12a, 12b by an inset bolt and nut, a band, apertures, adhesives, screws, nails, pins, divets, sockets, clips, clamps, clasps, channels, grooves, hooks, joints, latches, locks, recesses, slits or slots. The handle 12 may include an inward groove 20 such that the user can strip a cable wire W sheath H from the cable wire W. The inward groove 20, as shown in FIG. 3, is most effective when its diameter is less than that of the cable wire sheath H but greater than the diameter of the underlying cable wire W. One of ordinary skill in the art would realize that multiple inward grooves 20 can be included on the handle 12 and may be of varying diameters to accommodate different cable wire W and cable wire sheath H diameters. In use, the inward groove 20 is placed upon an aperture in the cable wire sheath H or at an exposed end of the cable wire sheath H. The user then pulls or pushes the handle 12 the length of the cable wire W, thus exposing the wire W.

The shoe 16 protects the underlying cable wire W and wire sheath H from the blade 18. During use, the shoe 16 is underneath the uncut cable sheath S. The shoe 16 is flat with a tapered end extending outward beyond the blade 18 to ease the entry of the shoe 16 into an opening in the cable C. The tapered end of the shoe 16 is rounded to prevent gouging or scoring the cable wire W or wire sheath H or the insulation on the inner cable wires. The shoe 16 may curve downward at one end, away from the blade 18 to deflect foreign objects away from the blade 18. The shoe 16 guides the user by allowing the user to pull up on the cable sheath S during use, pulling the sheath S away from the underlying cable wire W, thereby protecting the underlying cable wire W and wire sheath H from the blade 18. The shoe 16 enables the user to verify the blade 18 is deep enough into the sheath S to cut entirely through the sheath S without going too deep and cutting the underlying cable wire W or wire sheath H. The user need only pull upward on the handle 12 until resistance is felt which means the shoe 16 is encountering resistance from the underside of the cable sheath S. Because the shoe 16 extends outward beyond the blade 18, the shoe 16 ensures that the blade 18 is finger safe by preventing the user's finger F from reaching the blade 18.

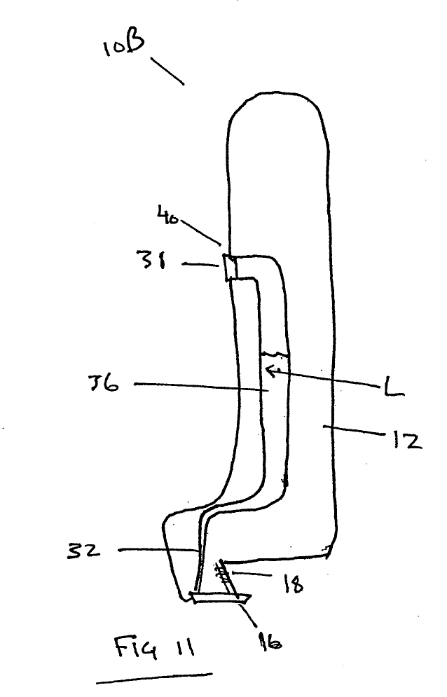

As shown in FIGS. 8-9, a container 28 may be attached to the cable stripper 10 to hold and dispense lubricant L. The container 28 is preferably cylindrical with an opening near the hook 14 when in use and is preferably located on the hook 14, as seen in FIG. 8. Lubricant L eases the insertion of the shoe 16 into an opening on the cable sheath S and eases movement of the shoe 16 under the cable sheath S during use. The container 28 can be attached to the cable stripper 10 by numerous apparatus, well known to those of skill in the art, such as a band 30 (as shown in FIG. 8), nuts, bolts, apertures, adhesives, screws, nails, pins, divots, sockets, clips, clamps, clasps, channels, grooves, hooks, joints, latches, locks, recesses, slits or slots. Preferably, the container 28 is removably attached to the hook 14 to allow the user to refill the container 28 or replace the container 28 as needed. One of ordinary skill in the art would realize that the container 28 should be angled away from the handle 12 or shaped so as to avoid interfering with the user's grasp on the handle 12 during use. One of ordinary skill in the art would further realize that the container 28 may be attached primarily or secondarily to the handle 12 in such a manner as to avoid interfering with the user's grasp on the handle 12 during use, such as securing the container 28 to the top of the handle 12.

In one embodiment, shown in FIG. 8, the lubricant L dispenses from the container 28 to the shoe 16 through an internal channel 32 from the hook 14 through the blade 18 to the shoe 16. The internal channel 32 slopes downward toward one end of said shoe 16. In an alternate embodiment, shown in FIG. 9, the lubricant L dispenses from the container 28 to the shoe 16 through an external tube 34 from the container 28 to the shoe 16. One of ordinary skill in the art would realize that the external tube 34 can be attached to the cable stripper 10 via numerous mechanisms, including: adhesives, nuts, bolts, apertures, screws, nails, pins, divets, sockets, clips, clamps, clasps, channels, grooves, hooks, joints, latches, locks, recesses, slits or slots.

In another embodiment, shown in FIG. 11, the cable stripper handle 12 contains a reservoir 36. The reservoir 36 connects into internal channel 32, 34 allowing the lubricant L to dispense to the shoe 16. The reservoir 36 contains an additional opening 40 permitting the user to fill the reservoir 36 with lubricant L. The cable stripper 10B is equipped with a stopper 38 which closes the additional opening 40 to prevent the lubricant L from escaping during use or storage. The 'stopper can anything capable of preventing lubricant escape such as a plug, cap, or cover.

In use in one embodiment, user dips shoe 16 of a cable stripper 10 into a lubricant L such that the shoe 16 is covered in lubricant L, inserts the cable stripper 10 into an open portion of the cable C such that the cable stripper shoe 16 is underneath the cable sheath S, as shown in FIG. 10, thereby allowing the cable stripper blade 18 to come into contact with the cable sheath S, and pulls the cable stripper 10 along the axis of the cable C, splitting the cable sheath S and stripping the cable C.

In use in one embodiment, as shown in FIG. 10, the user grabs the handle 12 such that the user's fingers wrap around the handle 12 and the user's thumb points upwards. The user then dips the shoe 16 into a lubricant. When a dispensing means is present on the cable stripper 10, the user can attach a container 28 with a band 30 to the cable stripper 10, causing lubricant to run down the internal channel 32 or the exterior tube 34 and onto the shoe 16. The user then inserts the shoe 16 into an opening in the cable sheath S or at an open end of the cable sheath S. The shoe 16 is placed just underneath the cable sheath S to prevent the blade 18 from contacting the cable wires W and wire sheaths H underneath the cable sheath S but allowing the blade 18 to come into contact with and cut the cable sheath S. The user then pulls the cable stripper 10 the length of the cable sheath S cutting the sheath S with the blade 18. The underlying cable wires W and wire sheaths H is exposed for maintenance, repair and splicing. Before storing the cable stripper 10 for use, the user may place the blade sheath 22 over the blade 18 by gently pushing the sheath 22 onto the blade 18. Prior to use, the user can simply pull the blade sheath 22 off of the blade 18.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. A cable stripper, comprising:
a handle configured to be normal to a cable during with the user's hand- arm line substantially parallel to the axis of the cable;
a hook with a shoe having rounded edges and a tapered end; and
a blade located on said hook such that said blade is substantially parallel to said handle and substantially normal to said cable axis.

2. The cable stripper of claim 1, wherein said blade is finger safe.

3. The cable stripper of claim 2, wherein said blade is 5/16 of an inch (0.794 cm) in length from said shoe to said hook.

4. The cable stripper of claims 1 or 2, wherein said blade is beveled.

5. The cable stripper of claims 1 or 2, wherein said handle further comprises an inward groove such that the user can strip a sheath from cable wire.

6. The cable stripper of claims 1 or 2, wherein said handle comprises a first portion and a second portion; corresponding apertures on said first and second handle portions; and wherein said blade comprises a long, extended portion having apertures corresponding to said first and second handle portion apertures; and a securing means such that said blade is secured between said first and second portions.

7. The cable stripper of claims 1 or 2, further comprising a protective blade sheath such that said blade can be covered with said sheath when not in use.

8. The cable stripper of claims 1 or 2, further comprising a container; attachment means to fix said container to said cable stripper; lubricant inside said container; and a dispensing means for transporting said lubricant from said container to said shoe.

9. The cable stripper of claims 1 or 2, wherein said handle contains a reservoir;
lubricant inside said reservoir; refilling means to add additional lubricant into said reservoir; and dispensing means for transporting said lubricant from said reservoir to said shoe.

10. The cable stripper of claims 8 or 9, wherein the dispensing means for delivering said lubricant from said container to said shoe comprises an internal channel from said hook through said blade to said shoe.

11. The cable stripper of claims 8 or 9, wherein the dispensing means for delivering said lubricant from said container to said shoe comprises an external tube from said container to said shoe.

12. A cable stripper, comprising:
a hook;
a shoe on said hook, having rounded edges and a tapered end;
a finger safe blade located on said hook such that said blade is substantially parallel to said handle and said blade is at an obtuse angle to said shoe; and
an ergonomic means for pulling or pushing said blade during use.

13. The cable stripper of claim 12 wherein said ergonomic means comprises a handle normal to the cable during use.

14. A cable stripper, comprising:
a handle having a first portion and a second portion with a corresponding aperture, said handle having a normal orientation to the cable during use;
an inward groove on said handle such that the user can strip a sheath from cable wire small in diameter;
a hook;
a shoe on said hook, having rounded edges and a tapered end;
a finger safe blade located on said hook, said blade at an obtuse angle to said shoe, said blade having a beveled edge and an extending portion and an aperture corresponding to said first and second portions of said handle and said apertures on said first and second portions of said handle;
a securing means such that said blade is secured between said first and second portions of said handle via said apertures of said first and second portions and said aperture of said blade;
a container having a lubricant inside;
an attachment means to fix said container to said cable stripper; and
an internal channel from said hook through said blade to said shoe such that said internal channel slopes downward toward one end of said shoe dispensing said container's lubricant down said tube and at one end of said shoe.

15. The cable stripper of claim 14, wherein said blade is 5/16 of an inch (0.794 cm) in length from said shoe to said hook.

16. A method for stripping a cable wire sheath comprising the steps of:
dipping a shoe of a cable stripper into a lubricant such that the shoe is covered in lubricant;
inserting a cable stripper into an open portion of the cable wire sheath such that the cable stripper shoe is underneath the cable sheath thereby allowing the cable stripper blade to come into contact with the cable sheath; and
pulling the cable stripper along the axis of the cable sheath, splitting the cable sheath and stripping the cable.
